(19) United States
(12) Patent Application Publication
(10) Pub. No.: US 2005/0259152 A1
(43) Pub. Date: Nov. 24, 2005

(54) System and method for video viewing and payment

(75) Inventor: Shou-Kang Wei, Taipei (TW)

Correspondence Address: BIRCH STEWART KOLASCH & BIRCH, PO BOX 747, FALLS CHURCH, VA, 22040-0747, US

(73) Assignee: AverMedia TECHNOLOGIES, INC.

(21) Appl. No.: 11/123,106

(22) Filed: May 6, 2005

(30) Foreign Application Priority Data
May 7, 2004 (TW) 93113013

(51) Int. Cl. H04N 7/18

(52) U.S. Cl. 348/159

(57) ABSTRACT

A video monitor and payment system including N cameras, a digital video recorder, and a video selection and fee counter is provided. The digital video recorder is for receiving and storing N continuously fetched videos shot and outputted by the N cameras. The video selection and fee counter has a video selection database. The web page of the video selection database has N video channels linked to N continuously fetched videos stored in the digital video recorder. When the user is at the client end and is linked to the web page of the video selection database via the Internet, the user selects M video channels from the N video channels and views M continuously fetched videos of the M selected video channels. The video selection and fee counter obtains video viewing fee, wherein M is a positive integer smaller than or equal to N.

This application claims the benefit of Taiwan application Serial No. 93113013, filed May 7, 2004, the subject matter of which is incorporated herein by reference.

### BACKGROUND OF THE INVENTION

1. Field of the Invention

The invention relates in general to a system and a method for video monitor, and more particularly to a system and a method for video monitor and payment.

2. Description of the Related Art

With the advance in science and technology, the video monitor system has become an essential part to modern people with regards to the security of their lives. Normally, a video monitor system uses several cameras to continuously shoot the sceneries and uses a digital video recorder (DVR) to receive the video continuously shot by the cameras. The digital video recorder uses digital technology to compress/decompress the video images, not only prolonging the length of recording time, but also resolving the problem of signal decay occurs in video tapes. Furthermore, with regards to the playback of a video tape, the user can search for particular images according to the parameters such as date, time, camera and alarm records. Especially, the shift detecting function of the digital video recorder can achieve precise monitoring by setting a shift detecting region to individual camera. Besides, the DVR can further be integrated with the Internet to transmit digital video signal via the Internet. The user can monitor the venue at a remote end via a computer browser. All the settings and operations are the same as in a host computer, so the user can monitor the security information of the venue of shooting whenever and wherever it is needed.

However, current video monitor systems are too expensive and go beyond the affordability of ordinary office clan. Therefore, the video monitor system, which allows the users to view their desired video such as a kindergarten where a user's kids go to, a ward where a user's family member is hospitalized, or a cell at which a user's friend is retained, becomes inaccessible to ordinary people.

### SUMMARY OF THE INVENTION

It is therefore an object of the invention to provide a system and a method for video monitor and payment, with the design of calculating the fee according to the categories and lengths of time of continuously fetched videos viewed by the user, allows the user to continuously view monitored videos whenever and wherever desired, saving the cost of purchasing a conventional video monitor system.

According to an object of the invention, a video monitor and payment system including N cameras, a digital video recorder, and a video selection and fee counter is provided. The N cameras are for continuously shooting N sceneries and correspondingly outputting N continuously fetched videos, wherein N is a positive integer. The digital video recorder is for receiving and storing N continuously fetched videos outputted by the N cameras. The video selection and fee counter has a video selection database. The web page of the video selection database has N video channels linked to N continuously fetched videos stored in the digital video recorder. When the user is at a client end and is linked to the web page of the video selection database via the Internet, the user, via the web page of the video selection database, selects M video channels from the N video channels and uses the client end to view M continuously fetched videos of the M selected video channels. The video selection and fee counter, according to respective categories and lengths of browsing time of the M continuously fetched videos viewed by the user, obtains video viewing fee, wherein M is a positive integer smaller than or equal to N.

According to another object of the invention, a method for video viewing and payment to be used in a video monitor and payment system is provided. The video monitor and payment system includes a digital video recorder and a video selection and fee counter. The digital video recorder is for storing N continuously fetched videos, wherein N is a positive integer. The video selection and fee counter has a video selection database. The web page of the video selection database has N video channels linked to N continuously fetched videos stored in the digital video recorder. In the method, firstly, the user is at a client end and is linked to the web page of the video selection database via an Internet. Next, the user, via the web page of the video selection database, selects M video channels from the N video channels and uses the client end to view M continuously fetched videos of the M selected video channels, wherein M is a positive integer smaller than or equal to N. Then, when user switches off the M continuously fetched videos, the video selection and fee counter, according to respective categories and lengths of browsing time of the M continuously fetched videos viewed by the user, obtains a video viewing fee to be paid by the user

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a configuration of a video monitor and payment system, an Internet and a client end according to a preferred embodiment of the invention;

FIG. 2 is a flowchart of method for video viewing and payment applied in the video monitor and payment system of FIG. 1; and

FIG. 3 is a flowchart of the step of selecting and viewing the selected video by the user of FIG. 2.

### DETAILED DESCRIPTION OF THE INVENTION

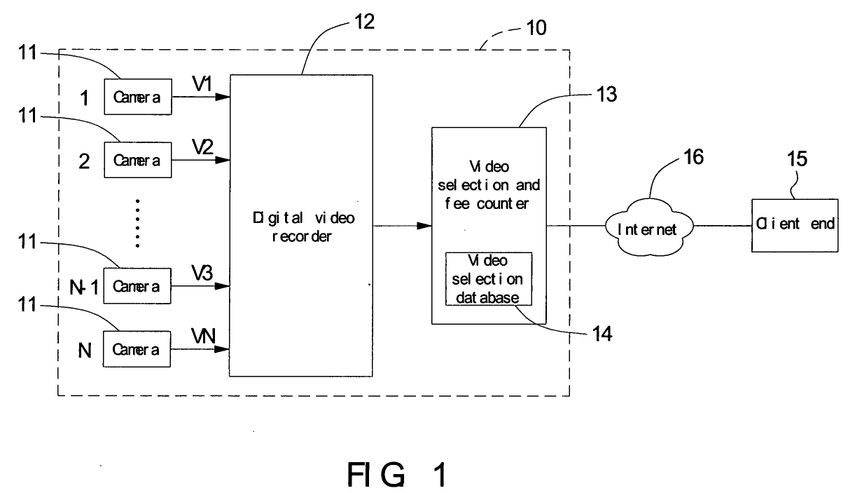

Referring to FIG. 1, a configuration of a video monitor and payment system, an Internet and a client end according to a preferred embodiment of the invention is shown. In FIG. 1, a video monitor and payment system 10 includes at least a camera 11, a digital video recorder (DVR) 12 and a video selection and fee counter 13. The present preferred embodiment is exemplified by N cameras 11, wherein N is a positive integer. The N cameras 11 are for continuously shooting N sceneries and correspondingly outputting N continuously fetched videos V1˜VN to the digital video recorder 12. The digital video recorder 12 is for receiving and storing the N continuously fetched videos V1˜VN outputted by the N cameras 11. The video selection and fee counter 13 has a video selection database 14 whose the web page has N video channels linked to the N continuously fetched videos stored in the digital video recorder.

When a user is at a client end 15 and is linked to the web page of the video selection database 14 via an Internet 16, the user selects M video channels from the N video channels and uses the client end 15 to view M continuously fetched videos of the M selected video channels via the web page of the video selection database 14. After the user finishes viewing the M continuously fetched videos, the video selection and fee counter 13 obtains a video viewing fee to be paid by the user according to respective categories and lengths of browsing time of the M continuously fetched videos viewed by the user, wherein M is a positive integer smaller than or equal to N.

Normally, the client end 15 has a display unit for displaying videos. Suppose the user selects four video channels, the display unit can sequentially display respective continuously fetched video of the four video channels for the user to sequentially view the four continuously fetched videos. Furthermore, the display unit can display continuously fetched videos of the four video channels at the same time for the user to view the same.

Furthermore, according to the categories of the video continuously shot by respective camera, the video selection and fee counter 13 can obtain the fee for respective of continuously fetched video viewed by the user for a pre-determined time. Besides, the contents of the N sceneries can be determined according to individual user's needs. For example, the scenery can be a kindergarten where the user's kids go to, a ward where the user's family member is hospitalized, or a cell at which the user's friend is retained. The N sceneries further include world famous sceneries or speeches made by VIPs or celebrities.

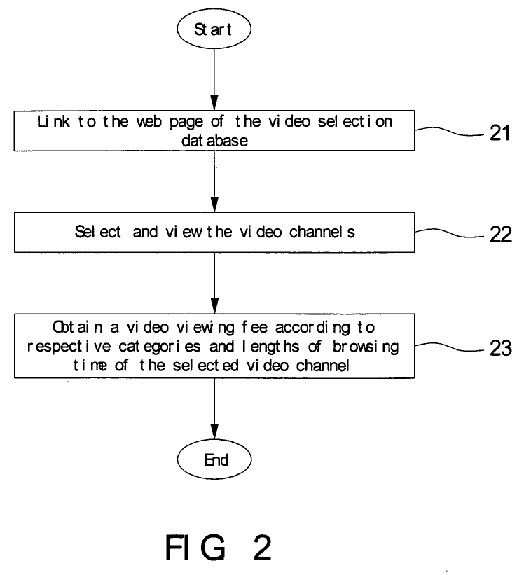

Referring to FIG. 2, a flowchart of method for video viewing and payment applied in the video monitor and payment system of FIG. 1 is shown. In FIG. 2, the method begins at step 21 that a user at the client end 15 links to the web page of the video selection database 14 via an Internet 16. In step 21, when the user is at the client end and 15 and is first linked to the web page of the video selection database 14 via the Internet 16, the user registers a user data on the web page of the video selection database 14. The video selection and fee counter 13 stores the user data whereby identity verification is affirmed when the user is again linked to the web page of the video selection database 14 via the Internet 16 at any client end. The user data includes a first nickname, a first user password, a telephone number, a facsimile number, a postal address and an E-mail address.

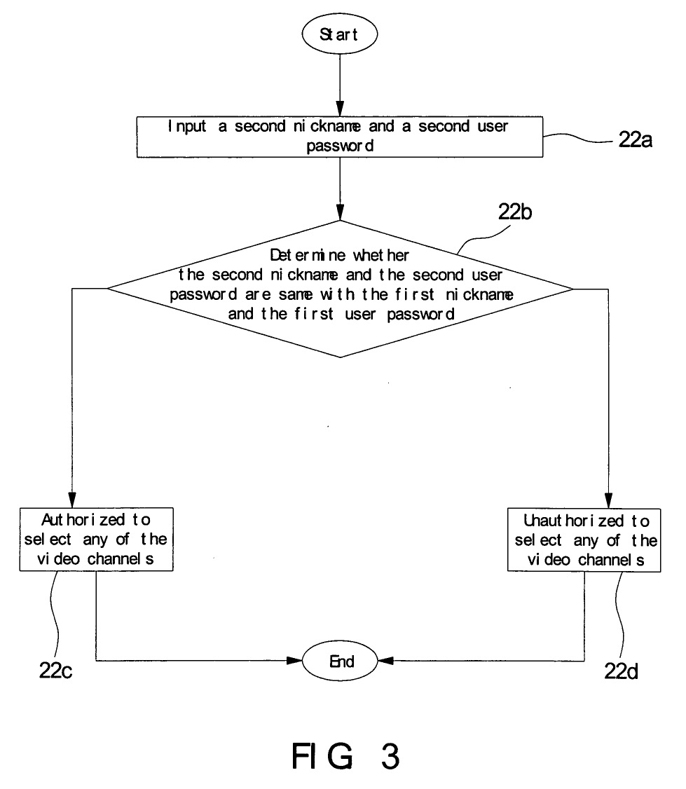

Next, in step 22, the user selects M video channels from the N video channels and uses the client end 15 to view M continuously fetched videos of the M selected video channels via the web page of the video selection database 14. In the present preferred embodiment, step 22 can be further divided into several sub-steps as shown in FIG. 3. FIG. 3 begins at step 22a, whenever the user would like to view a video channel, the user inputs a second nickname and a second user password into the web page of the video selection database 14 via client end 15. Next, in step 22b, whether the second nickname and the second user password are the same with the first nickname and the first user password is determined by video selection and fee counter 13. When the second nickname and the second user password are determined to be the same with the first nickname and the first user password by video selection and fee counter 13, proceed to step 22c, the video selection and fee counter 13 grants an eligible user authorization to select video channels. The user is authorized to select any video channel from the N video channels, for instance, M channels. When the second nickname and the second user password are determined to be different from the first nickname and the first user password by the video selection and fee counter 13, the user does not have the authorization to select any video channel from the N video channels.

When the user is viewing the M selected videos, the video selection and fee counter 13 records a start time of respective of the continuously fetched videos. When user switches off the M continuously fetched videos, as shown in step 23, the video selection and fee counter 13 records an end time of respective of the continuously fetched video. The time difference between the end time and the start time of respective of continuously fetched videos is equal to the length of browsing time of respective continuously fetched video viewed by the user. Therefore, the video selection and fee counter 13 obtains a video viewing fee to be paid by the user according to respective categories and lengths of browsing time of the M continuously fetched videos viewed by the user.

In the present preferred embodiment, after the video viewing fee is obtained by the video selection and fee counter 13, the video monitor and payment system 10 can provide several payment informative methods to inform the user of fee payment. According to the first informative method, the provider of the video monitor and payment system 10 informs the user of the video viewing fee and a payment method according to user data via a mail, an E-mail, a telephone, a facsimile or a short message. According to the second informative method, the video monitor and payment system 10 can inform the user of the video viewing fee and a payment method according to user data via an E-mail, a voice message, a facsimile or a short message. According to the third informative method, the video selection and fee counter 13 displays the video viewing fee and a payment method on the web page of the video selection database 14. The user can browse the web page of the video selection database 14 to obtain video viewing fee and payment method via the client end 15. When the payment notice is received by the user, the user can pay the video viewing fee via credit card Internet payment, ATM fund transfer, remittance or cash mail.

If the user purchases prepaid points or electronic cash, video monitor and payment system 10 would deduct video viewing fee from the user's prepaid points or electronic cash, and the video monitor and payment system 10 would inform the user of remaining points, electronic cash or deficiency of points or cash according to the above payment method.

Anyone who is skilled in the technology will understand that the technology of the invention is not limited thereto. For example, the video selection and fee counter 13 can be disposed in the digital video recorder 12. Furthermore, the client end 15 is a portable electronic device or a computer. Besides, the client end 15 is linked to the Internet 16 via a cable or wirelessly.

With the design of calculating the fee according to the categories and lengths of time of continuously fetched videos viewed by the user, the video monitor and payment system in above embodiment of the invention allows the user to continuously view monitored videos whenever and wherever desired, saving the cost of purchasing a conventional video monitor and payment system.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A video monitor and payment system, comprising:
N cameras for continuously shooting N sceneries and correspondingly outputting N continuously fetched videos, wherein N is a positive integer;
a digital video recorder (DVR) for receiving and storing the N continuously fetched videos outputted by the N cameras;
a video selection and fee counter having a video selection database, wherein the web page of the video selection database has N video channels lined to the N continuously fetched videos stored in the digital video recorder, and when a user is at a client end and is linked to the web page of the video selection database via an Internet, the user selects M video channels from the N video channels and uses the client end to view the M continuously fetched videos of the M selected video channels via the web page of the video selection database, the video selection and fee counter obtains a video viewing fee to be paid by the user according to respective categories and lengths of browsing time of the M continuously fetched videos viewed by the user, M is a positive integer smaller than or equal to N.

2. The system according to claim 1, wherein when the user is at the client end and is first linked to the web page of the video selection database via the Internet, the user registers a user data on the web page of the video selection database, the video selection and fee counter stores the user data.

3. The system according to claim 2, wherein the user data includes a first nickname, a first user password, a telephone number, a facsimile number, a postal address and an E-mail address.

4. The system according to claim 3, wherein when the user is at the client end and is linked to the web page of the video selection database via the Internet, the user inputs a second nickname and a second user password into the web page of the video selection database via the client end, and when the second nickname and the second user password are determined by the video selection and fee counter to be the same with and the first nickname and the first user password, the user selects the M video channels via the web page of the video selection database.

5. The system according to claim 3, wherein when the video selection and fee counter obtains the video viewing fee, a provider of the video monitor and payment system, according to the user data, informs the user of the video viewing fee and a payment method via a mail, an E-mail, a telephone, a facsimile or a short message.

6. The system according to claim 3, wherein when the video selection and fee counter obtains the video viewing fee, the video monitor and payment system, according to the user data, informs the user of the video viewing fee and a payment method via an E-mail, a voice message, a facsimile or a short message.

7. The system according to claim 1, wherein when the video selection and fee counter obtains the video viewing fee, the video selection and fee counter displays the video viewing fee and a payment method on the web page of the video selection database, the user can brow the web page of the video selection database to obtain the video viewing fee and the payment method via the client end.

8. The system according to claim 1, wherein the video selection and fee counter can be disposed in the digital video recorder.

9. The system according to claim 1, wherein the client end is a portable electronic device or a computer.

10. The system according to claim 1, wherein the client end is linked to the Internet via a cable or wirelessly.

11. A method for video monitor and payment used in a video monitor and payment system, the video monitor and payment system including a digital video recorder and a video selection and fee counter, the digital video recorder for storing N continuously fetched videos, N is a positive integer, the video selection and fee counter having a video selection database, the web page of the video selection database having N video channels linked to the N continuously fetched videos stored in the digital video recorder, the method comprising:
linking a user from a client end to the web page of the video selection database via an Internet;
selecting M video channels from the N video channels and using the client end to view the M continuously fetched videos of the M selected video channels by the user via the web page of the video selection database, M is a positive integer smaller than or equal to N; and
obtaining a video viewing fee by the video selection and fee counter according to respective categories and lengths of browsing time of the M continuously fetched videos when the user closes the M continuously fetched videos.

12. The method according to claim 11, wherein the linking step further comprises:
registering a user data registers on the web page of the video selection database by the user and storing the user data by the video selection and fee counter when the user is first linked to the web page of the video selection database from the client end via the Internet.

13. The method according to claim 12, wherein the user data comprises a first nickname, a first user password, a telephone number, a facsimile number, a postal address and an E-mail address.

14. The method according to claim 13, wherein the selecting step further comprises:
inputting a second nickname and a second user password into the web page of the video selection database via the client end by the user;
determining whether the second nickname and the second user password are the same with the first nickname and the first user password by the video selection and fee counter;
selecting the M video channels via the web page of the video selection database by the user when the second nickname and the second user password are determined to be the same with the first nickname and the first user password by the video selection and fee counter; and
failing to select any video channel from the N video channels by the user when the second nickname and the second user password are determined to be different with the first nickname and the first user password by the video selection and fee counter.

15. The method according to claim 13, wherein after the obtaining step, the method further comprises:
informing the user of the video viewing fee and a payment method via a mail, an E-mail, a telephone, a facsimile or a short message by a provider of the video monitor and payment system according to the user data.

16. The method according to claim 13, wherein after the obtaining step, the method further comprises:
informing the user of the video viewing fee and a payment method via an E-mail, a voice message, a facsimile or a short message by the video monitor and payment system according to the user data.

17. The method according to claim 11, wherein after the obtaining step, the method further comprises:
displaying the video viewing fee and a payment method on the web page of the video selection database by the video selection and fee counter, and thus the user knowing the video viewing fee and the payment method by browsing the web page via the client end.

18. The method according to claim 11, wherein the video selection and fee counter can be disposed in the digital video recorder.

19. The method according to claim 11, wherein the client end is a portable electronic device or a computer.

20. The method according to claim 11, wherein the client end is linked to the Internet via a cable or wirelessly.
